(19) United States
(12) Patent Application Publication
(10) Pub. No.: US 2026/0273772 A1
(43) Pub. Date: Sep. 17, 2026

(54) END EFFECTOR

(71) Applicant: HONDA MOTOR CO., LTD., Tokyo (JP)

(72) Inventor: Hironori WAITA, Saitama (JP)

(21) Appl. No.: 19/533,868

(22) Filed: Feb. 9, 2026

(30) Foreign Application Priority Data
Mar. 14, 2025 (JP) 2025-041209

(51) Int. Cl. B25J 13/08; B25J 15/00

(52) U.S. Cl. CPC B25J 13/087; B25J 13/084; B25J 15/0009

(57) ABSTRACT

An end effector includes a contact member having light permeability and including a contact surface configured to come into contact with a target object, a first imager configured to image the contact surface from inside the contact member at an angle equal to or less than a critical angle for total reflection, and a second imager configured to image the contact surface from inside the contact member at an angle greater than the critical angle for the total reflection.

### TECHNICAL FIELD

The present invention relates to an end effector used for a robot hand.

### BACKGROUND ART

A known end effector used for a robot hand is provided with fingers, is shaped like a human hand, and has a camera attached to the tip of each finger (for example, JP2023-105586A).

A known optical touch sensor to be installed in a robot hand includes a hemispherical contact body made of an elastic body having light permeability and including a contact surface configured to come into contact with a target object, grid-like markers added to the contact surface, and an imaging element configured to image the markers in a normal direction thereof from inside the contact body (for example, JP2022-66750A).

The end effector described in JP2023-105586A can acquire the image information about the whole image of the target object of the end effector as the camera images the external environment. However, according to such an end effector, it is difficult to detect based on the image information output by the camera that the target object comes into contact with the contact surface of the end effector.

In other words, light transmission imaging, which images the light from the normal direction of the contact surface of the end effector with which the target object comes into contact, can easily determine the position and posture of both non-contact and close-contact target objects, but can hardly detect that the target object comes into contact with the contact surface.

The optical touch sensor described in JP2022-66750A can detect that the target object comes into contact with the contact surface of the contact body, but cannot acquire the image information about the whole image of the target object.

The optical touch sensor of an internal reflection type described in JP2022-66750A, which reflects light rays from inside the contact body by a reflection film formed along the contact surface, can detect that the target object comes into contact with the contact surface as the reflection state of the reflection film changes due to deformation of the reflection film (the contact surface). However, the image information that can be acquired is limited to only the portion of the target object that comes into contact with the contact surface. If the target object is a small screw and the contact force is small, the image information can only be acquired from two locations: the head of the screw and the tip of the threaded portion. There is a trade-off that the contact surface preferably has light permeability to acquire the whole image of the target object while the contact surface is preferably composed of a reflection surface that does not have light permeability to detect the deformation of the contact surface.

### SUMMARY OF THE INVENTION

In view of the above background, an object of the present invention is to provide an end effector that can overcome the abovementioned trade-off, that is, that can obtain the whole image of the target object and detect that the target object comes into contact with the contact surface.

To achieve such an object, one aspect of the present invention provides an end effector comprising: a contact member having light permeability and including a contact surface configured to come into contact with a target object; a first imager configured to image the contact surface from inside the contact member at an angle equal to or less than a critical angle for total reflection; and a second imager configured to image the contact surface from inside the contact member at an angle greater than the critical angle for the total reflection.

Further, to achieve such an object, another aspect of the present invention provides an end effector comprising: a contact member having light permeability and including a contact surface configured to come into contact with a target object; a normal direction imager configured to image the contact surface in a normal direction thereof from inside the contact member; and a tangential direction imager configured to image the contact surface in a tangential direction thereof from inside the contact member.

According to these aspects, the end effector can acquire the image information about the whole image of the target object and detect that the target object comes into contact with the contact surface.

### BRIEF DESCRIPTION OF THE DRAWING(S)

FIG. 1 is a perspective view of a robot arm including an end effector according to the present embodiment;

FIG. 2 is a vertical cross-sectional view of the end effector according to the present embodiment; and

FIGS. 3A and 3B are explanatory diagrams of a pattern used for the end effector according to the present embodiment.

### DETAILED DESCRIPTION OF THE INVENTION

In the following, an end effector according to an embodiment of the present invention will be described with reference to the drawings.

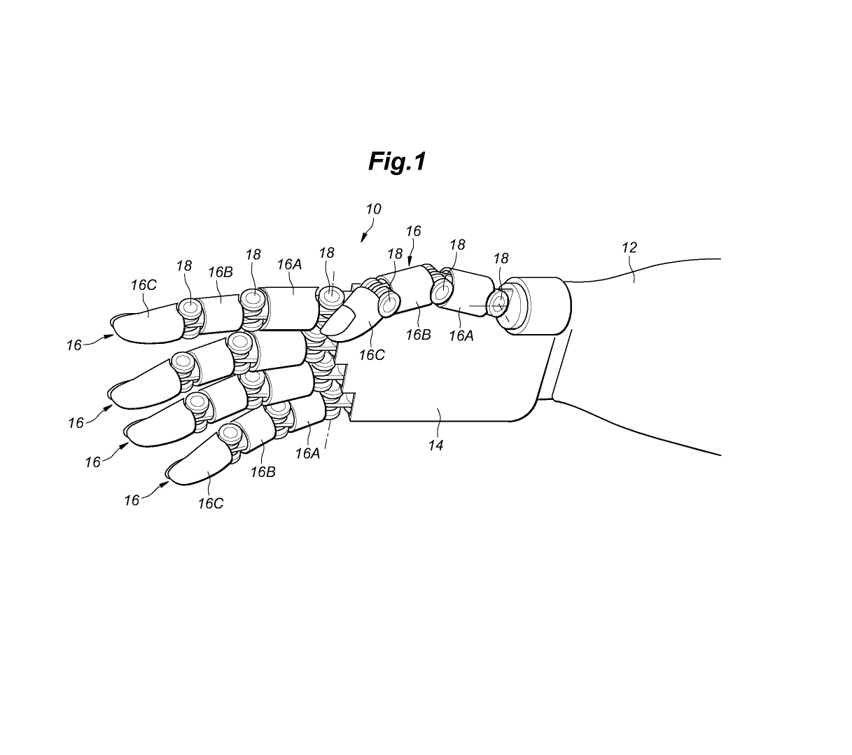

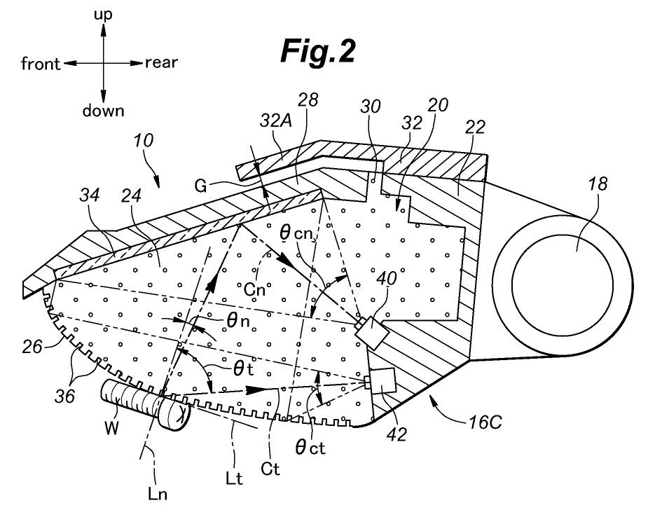

As shown in FIG. 1, an end effector 10 is attached to the tip of a robot arm 12. The end effector 10 picks up a target object W and recognizes the existence thereof. In the following description, a bolt will be referred to as the target object W (see FIG. 2).

The end effector 10 is shaped like a human hand including a palm 14 and five fingers 16 provided on the palm 14. Each finger 16 has a base portion 16A, a middle portion 16B, and a tip portion 16C that are connected to each other so as to bend and extend via a plurality of rotating portions 18 corresponding to joints.

As shown in FIG. 2, an optical sensor 20 is provided on the tip portion 16C of the finger 16 corresponding to the thumb. Optical sensors 20 may also be provided on the tip portions 16C of the fingers 16 corresponding to the index finger, the middle finger, the ring finger, and the little finger.

The optical sensor 20 includes a support member 22 attached to the rotating portion 18. A contact member 24, which is shaped like a human fingertip, is integrally provided on a front side as viewed in FIG. 2 of the support member 22. The contact member 24 is a molded product made of an elastic body (elastomer body) having light permeability, such as transparent urethane rubber, and is joined to the support member 22. The contact member 24 has a contact surface 26, which is a curved surface that can come into contact with the target object W, on a lower side as viewed in FIG. 2.

A back plate 28, which is shaped like a human nail, is joined to a side (an upper side as viewed in FIG. 2) of the contact member 24 facing away from the contact surface 26. The back plate 28 is made of metal or resin and has higher rigidity than the contact member 24.

The support member 22 and the back plate 28 may be joined to the contact member 24 by insert molding of the contact member 24.

From a different perspective, the back plate 28 is connected to the support member 22 via an elastic member 30. The elastic member 30 is formed by a portion of the contact member 24. With the elastic member 30 serving as a flexible hinge, the back plate 28 can move together with the contact member 24 relative to the support member 22 substantially in the up-and-down direction as viewed in FIG. 2.

A stopper member 32 is attached to the support member 22. The stopper member 32 includes a stopper piece 32A facing the upper surface of the back plate 28 at a prescribed interval G as viewed in FIG. 2. The stopper member 32 defines an upward moving range as viewed in FIG. 2 of the back plate 28 as the back plate 28 comes into contact with the stopper piece 32A.

A mirror 34 is attached to a surface (a lower surface as viewed in FIG. 2) of the back plate 28 facing the contact member 24. The mirror 34 is composed of a total reflection mirror and is directed to the contact surface 26 from inside the contact member 24.

The contact member 24 is provided with a pattern 36 formed along the contact surface 26. The pattern 36 is composed of a lattice arrangement, grooves such as stripes in the front-and-rear direction or lateral direction, or dot-like recesses such as hemispherical recesses. The pattern 36 may have any configuration as long as a tangential direction camera 42 (described later) can image the pattern 36 from inside the contact member 24.

A normal direction camera 40 (a normal direction imager and a first imager) and a tangential direction camera 42 (a tangential direction imager and a second imager) are attached to a side of the support member 22 facing the contact member 24. Each of the normal direction camera 40 and the tangential direction camera 42 is an electronic imager (imaging device) including an imaging element such as a CCD or CMOS, a lens, and the like, and is capable of capturing static images and videos. The normal direction camera 40 and the tangential direction camera 42 do not necessarily require the lens.

The normal direction camera 40 is attached to the support member 22 with an upward inclined state as viewed in FIG. 2, faces the mirror 34, and has a prescribed angle of view θcn with an imaging range covering substantially the entire mirror 34. The normal direction camera 40 receives the reflection light (optical image) from the mirror 34 and images the contact surface 26 from inside the contact member 24 at an angle θn equal to or less than a critical angle for total reflection of the contact surface 26. The mirror 34 establishes an optical path from the contact surface 26 to the normal direction camera 40 so that the normal direction camera 40 can image the contact surface 26 at the angle θn equal to or less than the critical angle for the total reflection of the contact surface 26.

The normal direction camera 40 images the contact surface 26 from inside the contact member 24 in a direction close to a normal Ln of the contact surface 26, and is capable of imaging the external environment of the contact surface 26 from inside the contact member 24 through the contact surface 26. The normal direction camera 40 can be referred to as a camera for capturing a transmission image.

The tangential direction camera 42 is attached substantially horizontally to the support member 22 as viewed in FIG. 2, faces the contact surface 26, and has a prescribed angle of view θct with an imaging range covering substantially the entire contact surface 26. The tangential direction camera 42 images the contact surface 26 from inside the contact member 24 at an angle θt greater than the critical angle for the total reflection of the contact surface 26. That is, the tangential direction camera 42 images the contact surface 26 from inside the contact member 24 in a direction close to a tangent Lt of the contact surface 26. The tangential direction camera 42 is capable of imaging the contact surface 26 and the pattern 36 formed along the contact surface 26 from inside the contact member 24, using the contact surface 26 as a reflection surface. The tangential direction camera 42 can be referred to as a camera for capturing an internal reflection image.

The angle θn equal to or less than the critical angle for the total reflection of the contact surface 26 and the angle θt greater than the critical angle for the total reflection thereof are angles that exist on one virtual plane, as shown in FIG. 2. This virtual plane is perpendicular to the contact surface 26 in a state where the contact member 24 does not elastically deform, and includes a central optical axis Cn of the normal direction camera 40 and a central optical axis Ct of the tangential direction camera 42.

According to the above configuration, the normal direction camera 40 images the contact surface 26 from inside the contact member 24 at the angle θn equal to or less than the critical angle for the total reflection. Accordingly, the normal direction camera 40 permeably images the external environment of the contact surface 26 from inside the contact member 24, and acquires the image information about the whole image as a transmission image including the shape, position, and posture of the target object W in the external environment of the contact surface 26.

It is difficult to detect that the target object W comes into contact with the contact surface 26 based on the image information about the whole image of the target object W acquired by the normal direction camera 40. However, it is possible to reliably and easily determine and recognize the shape, position, and posture of the target object W based on the image information about the whole image thereof.

The tangential direction camera 42 images the contact surface 26 from inside the contact member 24 at the angle θt greater than the critical angle for the total reflection. Accordingly, the tangential direction camera 42 images the contact surface 26 as a reflection surface from inside the contact member 24, and acquires the image information with the contact surface 26 as a reflection surface. That is, the tangential direction camera 42 images the light permeable contact surface 26 as a reflection surface by utilizing the total reflection phenomenon of the contact surface 26.

As coming into contact with the target object W, the contact surface 26 elastically deforms according to the shape of the target object W, and the state of the internal reflection of the contact surface 26 changes. The image information about the internal reflection image acquired by the tangential direction camera 42 includes the abovementioned change in the state of the internal reflection of the contact surface 26. Accordingly, it is possible to reliably and easily detect that the target object W comes into contact with the contact surface 26 based on the image information about the internal reflection image acquired by the tangential direction camera 42.

The normal direction camera 40 images the contact surface 26 at the angle θn equal to or less than the critical angle for the total reflection, and the tangential direction camera 42 images the contact surface 26 at the angle θt greater than the critical angle for the total reflection. In this regard, the contact surface 26 refers to a gently curved area of the contact surface 26 with a large curvature that exists mainly in the central area of the contact surface 26.

Generally, it is thought that most of the area of the contact surface 26 with which the target object W comes into contact is the central area of the contact surface 26, which is a gently curved area with a large curvature. Accordingly, in many cases, the normal direction camera 40 can image the contact surface 26 at the angle θn equal to or less than the critical angle for the total reflection and the tangential direction camera 42 can image the contact surface 26 at the angle θt greater than the critical angle for the total reflection, even if the contact surface 26 is a curved surface.

When the contact surface 26 elastically deforms according to the shape of the target object W, an elastically deforming portion where the angle between the central optical axis Ct of the tangential direction camera 42 and the contact surface 26 becomes equal to or greater than the critical angle for the total reflection may occur. This portion of the contact surface 26 changes from an internal reflection surface to a light transmission surface. Accordingly, the tangential direction camera 42 images, in a light transmission manner, the contact portion of the target object W, which corresponds to the portion where the contact surface 26 changes from an internal reflection surface to a light transmission surface. The image information acquired by this imaging can also be used to detect that the target object W comes into contact with the contact surface 26.

Since the elastic deformation of the contact surface 26 changes according to the pressing force acting on the contact surface 26 due to contact with the target object W, the internal reflection of the contact surface 26 changes according to the pressing force of the target object W against the contact surface 26. Accordingly, it is possible to quantitatively measure the pressing force of the contact surface 26 against the target object W based on the image information from the tangential direction camera 42. This allows the optical sensor 20 to function as a touch sensor.

Since the contact member 24 is made of an elastic body such as urethane rubber, the elastic deformation of the contact surface 26 is large when the target object W comes into contact with the contact surface 26. This results in a greater change in the state of the internal reflection of the contact surface 26 when the target object W comes into contact with the contact surface 26, which makes it possible to more reliably detect that the target object W comes into contact with the contact surface 26 and more reliably measure the pressing force.

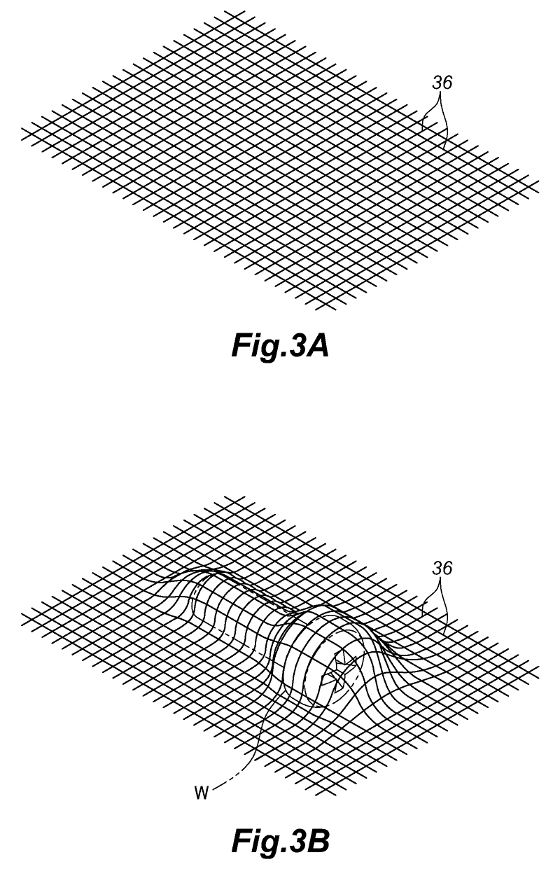

FIGS. 3A and 3B show a schematic diagram of the pattern 36 provided on the contact member 24 using wireframe drawing. As the target object W comes into contact with the contact surface 26, the pattern 36 provided on the contact member 24 along the contact surface 26 is deformed from a planar lattice shown in FIG. 3A to a three-dimensional (3D) lattice shown in FIG. 3B that follows the shape of the target object W.

The tangential direction camera 42 utilizes the contact surface 26 as a reflection surface and images the contact surface 26 and the pattern 36 as internal reflection images, so that the image information from the tangential direction camera 42 includes the image information about the above-mentioned deformation of the pattern 36. By using the image information about the pattern 36, it is possible to more reliably detect that the target object W comes into contact with the contact surface 26, and quantitatively measure the pressing force with high precision.

The normal direction camera 40 and the tangential direction camera 42 may be cameras with the same specifications, or may be a combination of cameras with different detection wavelength ranges, polarization characteristics, and the like. When the normal direction camera 40 and the tangential direction camera 42 are a combination of cameras with different detection wavelength ranges, polarization characteristics, and the like, the transmission image and the internal reflection image can be efficiently acquired by each of the normal direction camera 40 and the tangential direction camera 42.

The back plate 28, which has higher rigidity than the contact member 24, is a support member for the mirror 34 and also acts as a member to absorb the reaction force that occurs when the contact member 24 elastically deforms.

This ensures that the contact member 24 elastically deforms when the target object W comes into contact with the contact surface 26, and it is possible to surely detect that the target object W comes into contact with the contact surface 26 based on the image information from the tangential direction camera 42.

When the pressing force acts on the contact surface 26, the back plate 28 moves upward as viewed in FIG. 2 together with the mirror 34 relative to the support member 22 with the elastic member 30 serving as a flexible hinge. This movement reduces fluctuations in the positional relationship between the contact surface 26 and the mirror 34.

Accordingly, even if the contact surface 26 elastically deforms, the imaging angle of the normal direction camera 40 relative to the contact surface 26 is prevented from changing, and the normal direction camera 40 can capture the whole image of the target object W well.

Since the moving range of the back plate 28 in the substantially upward direction is defined by the stopper member 32, excessive movement of the back plate 28 in the substantially upward direction is suppressed, and therefore excessive elastic deformation of the contact member 24 is also suppressed. This improves the durability of the end effector 10.

As described above, the optical sensor 20 incorporated in the tip portion 16C of the finger 16 of the end effector 10 according to the present embodiment overcomes a trade-off that the contact surface 26 is preferably transparent (light permeable) to acquire the whole image of the target object W while the contact surface 26 is preferably an opaque reflection surface to detect that the target object W comes into contact with the contact surface 26 based on the deformation of the contact surface 26. This allows the optical sensor 20 to acquire the image information about the whole image of the target object W and to reliably and easily detect that the target object W comes into contact with the contact surface 26.

The embodiment is not limited to the above configuration and can be widely modified and implemented.

For example, the contact member 24 may be elastically deformable as being composed of an elastomer gel and a coating skin that have equivalent refractive indexes. In this case, the pattern 36 may be provided by printing and the like on the surface of the coating skin facing the elastomer gel.

The normal direction camera 40 may be arranged at the same position as the mirror 34. In this case, the mirror 34 can be omitted. A light source such as an LED may be provided to illuminate the contact surface 26 from inside. The normal direction camera 40 may image the contact surface 26 from inside the contact member 24 in a direction closer to the normal direction than a direction between the normal direction and the tangential direction, and the tangential direction camera 42 may image the contact surface 26 from inside the contact member 24 in a direction closer to the tangential direction than the direction between the tangential direction and the normal direction.

The above embodiment may also be described as follows:

In one embodiment, an end effector 10 comprises: a contact member 24 having light permeability and including a contact surface 26 configured to come into contact with a target object W; a normal direction camera 40 (first imager) configured to image the contact surface 26 from inside the contact member 24 at an angle θn equal to or less than a critical angle for total reflection; and a tangential direction camera 42 (second imager) configured to image the contact surface 26 from inside the contact member 24 at an angle θt greater than the critical angle for the total reflection.

According to this aspect, the normal direction camera 40 can acquire the image information about the whole image of the target object W, and the tangential direction camera 42 can detect that the target object W comes into contact with the contact surface 26.

Further, in another embodiment, an end effector 10 comprises: a contact member 24 having light permeability and including a contact surface 26 configured to come into contact with a target object W; a normal direction camera 40 (normal direction imager) configured to image the contact surface 26 in a normal direction thereof from inside the contact member 24; and a tangential direction camera 42 (tangential direction imager) configured to image the contact surface 26 in a tangential direction thereof from inside the contact member 24.

According to this aspect, the normal direction camera 40 can acquire the image information about the whole image of the target object W, and the tangential direction camera 42 can detect that the target object W comes into contact with the contact surface 26.

In the above embodiments, preferably, the contact member 24 is made of an elastic body configured to elastically deform upon contact with the target object W.

According to this aspect, using the tangential direction camera 42, it is possible to reliably detect that the target object W comes into contact with the contact surface 26 based on the elastic deformation of the contact member 24 caused by the contact of the target object W with the contact surface 26.

In the above embodiments, preferably, the contact member 24 is provided with a pattern 36 formed along the contact surface 26.

According to this aspect, the tangential direction camera 42 images the deformation of the pattern 36 due to the elastic deformation of the contact surface 26, so that the tangential direction camera 42 can reliably detect that the target object W comes into contact with the contact surface 26.

In the above embodiments, preferably, the end effector 10 further comprises a back plate 28 having higher rigidity than the contact member 24 and joined to a side of the contact member 24 facing away from the contact surface 26.

According to this aspect, the back plate 28 absorbs the reaction force generated by the elastic deformation of the contact member 24, which ensures that the contact member 24 elastically deforms when the target object W comes into contact with the contact surface 26, and it is possible to reliably detect that the target object W comes into contact with the contact surface 26 based on the image information from the tangential direction camera 42.

In the above embodiments, preferably, the end effector 10 further comprises a mirror 34 provided on a side of the back plate 28 facing the contact member 24, wherein the normal direction camera 40 is configured to receive reflection light from the mirror 34.

According to this aspect, the mirror 34 establishes an optical path from the contact surface 26 to the normal direction camera 40 so that the normal direction camera 40 can image the contact surface 26 at the angle θn equal to or less than the critical angle for the total reflection. The end effector 10 functions as a support member for the mirror 34.

In the above embodiments, preferably, the end effector 10 further comprises a support member 22 to which the contact member 24 is joined, wherein the back plate 28 is connected to the support member 22 via an elastic member 30.

According to this aspect, when the pressing force acts on the contact surface 26, the back plate 28 moves together with the mirror 34 relative to the support member 22 with the elastic member 30 serving as a flexible hinge, which suppresses fluctuations in the positional relationship between the contact surface 26 and the mirror 34.

In the above embodiments, preferably, the end effector 10 further comprises a stopper member 32 provided on the support member 22 and configured to define a moving range of the back plate 28 when the back plate 28 moves with the elastic member 30 serving as a flexible hinge.

According to this aspect, excessive movement of the back plate 28 is suppressed, and therefore excessive elastic deformation of the contact member 24 is also suppressed, which improves the durability.

1. An end effector, comprising:
a contact member having light permeability and including a contact surface configured to come into contact with a target object;
a first imager configured to image the contact surface from inside the contact member at an angle equal to or less than a critical angle for total reflection; and
a second imager configured to image the contact surface from inside the contact member at an angle greater than the critical angle for the total reflection.

2. The end effector according to claim 1, wherein the contact member is made of an elastic body configured to elastically deform upon contact with the target object.

3. The end effector according to claim 2, wherein the contact member is provided with a pattern formed along the contact surface.

4. The end effector according to claim 2, further comprising a back plate having higher rigidity than the contact member and joined to a side of the contact member facing away from the contact surface.

5. The end effector according to claim 4, further comprising a mirror provided on a side of the back plate facing the contact member,
wherein the first imager is configured to receive reflection light from the mirror.

6. The end effector according to claim 5, further comprising a support member to which the contact member is joined,
wherein the back plate is connected to the support member via an elastic member.

7. The end effector according to claim 6, further comprising a stopper member provided on the support member and configured to define a moving range of the back plate when the back plate moves with the elastic member serving as a flexible hinge.

8. An end effector, comprising:
a contact member having light permeability and including a contact surface configured to come into contact with a target object;
a normal direction imager configured to image the contact surface in a normal direction thereof from inside the contact member; and
a tangential direction imager configured to image the contact surface in a tangential direction thereof from inside the contact member.

9. The end effector according to claim 8, wherein the contact member is composed of an elastic body configured to elastically deform upon contact with the target object.

10. The end effector according to claim 9, wherein the contact member is provided with a pattern formed along the contact surface.

11. The end effector according to claim 9, further comprising a back plate having higher rigidity than the contact member and joined to a side of the contact member facing away from the contact surface.

12. The end effector according to claim 11, further comprising a mirror provided on a side of the back plate facing the contact member,
wherein the normal direction imager is configured to receive reflection light from the mirror.

13. The end effector according to claim 12, further comprising a support member to which the contact member is joined,
wherein the back plate is connected to the support member via an elastic member.

14. The end effector according to claim 13, further comprising a stopper member provided on the support member and configured to define a moving range of the back plate when the back plate moves with the elastic member serving as a flexible hinge.
